(19) United States
(12) Patent Application Publication
(10) Pub. No.: US 2015/0247074 A1
(43) Pub. Date: Sep. 3, 2015

(54) Method for Producing a Two-Component Polyurethane Composition Comprising One or More Additives Soluble in Polar Solvents

(71) Applicant: nolax AG, Sempach Station (CH)

(72) Inventors: Stephan Buser, Sursee (CH); Jessica Blume, Zurich (CH)

(21) Appl. No.: 14/399,267

(22) PCT Filed: May 8, 2013
(86) PCT No.: PCT/EP2013/059620

§ 371 Date: Mar. 16, 2015

(30) Foreign Application Priority Data
May 8, 2012 (EP) 12167071.5

(51) Int. Cl. C09J 175/08; C08G 18/73; C08G 18/32; C08K 5/29

(52) U.S. Cl. CPC C09J 175/08; C08K 5/29; C08G 18/73; C08G 18/3206

(57) ABSTRACT

A method for producing a two-component polyurethane composition comprising at least one additive soluble in polar solvents, in particular a biocide, comprising the following steps: a) providing at least one polyol; b) adding at least one solution of the polar solvent comprising at least one additive soluble in polar solvents, in particular a biocide, and at least one carrier material for the additive to the polyol from step a); and c) providing, in accordance with the requirements, at least one isocyanate for adding to the mixture from step b). The method has the advantage that additives can be incorporated into a two-component polyurethane composition without agglomerating or precipitating, without side reactions, and without an additional drying step.

### BACKGROUND OF THE INVENTION

The present invention relates to methods for producing a two-component polyurethane composition comprising one or more additives soluble in polar solvents, in particular biocides. Furthermore, it relates to two-component polyurethane compositions comprising one or more additives soluble in polar solvents, in particular biocides, obtainable by one of the methods according to the invention, and to the use of two-component polyurethane compositions comprising one or more additives soluble in polar solvents, in particular biocides, for producing foams and adhesives.

Hitherto, concentrated solutions of polar solvents which comprise additives soluble in polar solvents have only been able to be stably mixed into aqueous systems or single-component polyurethane compositions with a high water content on account of their solubility during the production in particular of foams. In the case of adhesives, a mixing-in only into hydrogels or aqueous dispersions was possible. With the exception in the case of the hydrogels, in all other cases an expensive drying step is necessary. Moreover, it is known that in the case of two-component polyurethanes the reaction between isocyanate and water competes with the reaction between isocyanate and polyols. For the modifiability, such as e.g. the adjustment of the physical and mechanical properties, of two-component polyurethanes, therefore, a small water fraction is desired.

The equipping of adhesives and absorbent foams with additives dissolved in polar solvents, in particular with biocides such as DMDM hydantoin, cetylpyridinium chloride, polyhexamethylenebiguanide (PHMB), their derivatives or mixtures thereof, dissolved in aqueous solution, or biocides such as clioquinol, triclosan and triphenylmethane dyes, their derivatives and mixtures thereof, dissolved in alcoholic solutions are required for diverse applications in medical technology.

Particularly hydrophilic, absorbent wound foams which are intended for absorbing infected wound exudate from the wound are preferably equipped with biocides in order to be able to kill the absorbed microorganisms, Adhesives equipped with biocides likewise have a broad application spectrum in medical technology and are used wherever a biocidal effect is also required as well as the joining of two substrates. This is the case for example for incision films or for catheter plasters.

For the production and biocidal equipping of a hydrophilic wound foam with very good absorption and retention properties, a formulation described in WO 2011015568 has been used which, on account of the high fraction of hydrophilic polymers, is particularly suited for the absorption and binding of wound exudates. The total water content in the polyol here is less than 5%. The direct mixing in of a 20% aqueous PHMB solution in the biocidally effective end concentration into the polyol mixture resulted immediately in a precipitate and the formation of a sticky PHMB sediment (comparative example 1). A mixing in of the PHMB solution in a lower concentration would be possible without exceptions, but as a result the required biocidally effective end concentration of for example 0.15%, based on the polyurethane foam, is not thereby achieved.

For the equipping of polyurethane wound foams with aqueous biocidal solutions which comprise PHMB, DMDM hydantoin, cetylpyridinium chloride, their derivatives or mixtures thereof, there are currently two approaches according to the prior art: often, the prepolymer-based wound foams are single-component systems and are foamed with a very high water content as e.g. in US 2010021514 A1 or WO 2004007595 A1. As a result, however, the formulation scope of hydrophilic polyols and therefore the subsequent ability to absorb and retain wound exudates is limited. Alternatively, the finished foams are impregnated after production with water-containing, biocidal solutions, which does not ensure a uniform distribution of the biocidal components on the surface. Moreover, the second case results in a “bulk release” of the biocidal components, as a result of which the activity subsides within a few hours after application (Wilhelms et al. (2007), “Freisetzung von Polyhexamethylenbiguandd (PHMB) aus der Wundauflage Suprasorb X+PHMB [Release of polyhexamethylenebiguanide (PHMB) from the wound covering Suprasorb X+PHMB]”, poster presentation DGfW). In both cases, a time-consuming and cost-intensive drying step has to be carried out.

EP 2 338 923 A1 describes a polyurethane which comprises a polyurea of two terminal isocyanates and a biocidal guanidinium as comonomer. The polyurethanes can be used to produce for example foams for mattresses. The biocidal additive here is incorporated directly into the polymer matrix and provides for the biocidal effect on the surface of the polymer. Disadvantages of EP 2 338 923 A1 are that firstly a high concentration of guanidinium (about 3%) has to be used to attain the biocidal effect and secondly that in the case of polymerizing in the biocide no long-distance effect as a result of release of the additives is possible, as is required for example for wound foams.

WO 9302717 A1 and U.S. Pat. No. 5,717,500 A describe the mixing in of chlorhexidine gluconate or other aqueous, biocide-containing solutions into aqueous dispersion adhesives which have to be applied to for example polyurethane films and then dried to achieve the adhesive strength.

As described in WO 2010/024928 A1 and WO 2010/025219 A1, biocidal hydrogel adhesives are used as “sandwich” constituents in absorbent wound coverings. The use of hydrogel adhesives here, however, have the disadvantage that, on account of their high water content, they have a tendency to dry out during use on the patient and therefore adversely influence the release and the efficacy of the biocidal components. The production of antimicrobial hydrogel adhesives is also very time-consuming on account of the long crosslinking times and pot lives.

It is therefore the object of the invention to overcome the disadvantages of the prior art, i.e. in particular to make it possible for solutions of polar solvents which comprise additives soluble in polar solvents to be able to he incorporated, in few working steps and without high time expenditure, into a two-component polyurethane composition without the additives agglomerating and precipitating out, or so much water being necessary that this leads to a high extent to secondary reactions with the, added isocyanates. Moreover, a drying step of a two-component polyurethane foam or adhesive should be avoided as far as possible, and a uniform distribution and prolonged efficacy of the additive as a result of delayed release should be ensured.

### DESCRIPTION OF THE INVENTION

This object is achieved by the subjects of the independent claims.

The methods according to the invention are suitable for incorporating solutions of polar solvents, particular aqueous or alcoholic solutions, comprising additives soluble in polar solvents into a two-component polyurethane composition without resulting in the stated disadvantages of the prior art.

One of the methods for producing a two-component polyurethane composition according to the invention comprising at least one additive soluble in polar solvents, in particular a water-soluble or alcohol soluble additive, in particular a biocide is characterized in that it involves the following steps:

a) the provision of at least one polyol;

b) addition of at least one solution of a polar solvent, in particular an aqueous or alcoholic solution comprising at least one additive soluble in polar solvents, in particular a water-soluble or alcohol-soluble additive, in particular a biocide, and at least one carrier material for the additive soluble in polar solvents to the polyol from step a); and

c) provision as required of at least one isocyanate for the addition to the mixture from step b).

The polar solvents used are preferably protic solvents such as water and alcohols. In the context of the invention, a solvent is understood. as being polar if the dielectric constant (relative permittivity) is or than 15.

To determine the relative permittivity, determination is preferably made using a Shering bridge at a frequency of 50 Hz, in accordance with international standard CEI/IEC 250: 1969.

The additive soluble in polar solvents added in this method to a two-component polyurethane composition has a solubility in water of at least 1% by weight, in particular of at least 7.5% by weight, and further in particular of at least 15% by weight. Solubilities in water of >25% by weight or else of >40% by weight are likewise possible. Preferably, the additive dissolved in polar solvents is a water-soluble biocide such as, for example, polyhexamethylenebiguanide (PHMB), DMDM hydantoin, cetylpyridinium chloride, their derivatives or mixtures thereof, or a biocide soluble in alcoholic solutions such as, for example, clioquinol, triclosan and triphenylmethane dyes, their derivatives or mixtures thereof. Chlorhexidine and tauroline can likewise be used in the context of the invention.

The carrier materials used in this method for additives soluble in polar solvents are inorganic fillers, in particular those with a BET surface area of ≧10 m²g preferably determined in accordance with DIN ISO 9277:2003-05); they are preferably hydrophilic inorganic fillers. Likewise particularly preferred fillers in the context are pyrogenic silica and silica gels with a BET surface area of ≧10 m²g (preferably determined in accordance with DIN ISO 9277:2003-05), as are known and commercially available for example under the trade names Aerosil® and Aerodisp®.

In the method described above, in a first step firstly at least one polyol is provided. Preference is given to using polyethylene glycols with the molecular weights between 100 and 8000, particularly preferably those with molecular weights between 200 and 4000. Furthermore, PEG/PPG copolymers with molecular weights between 100 and 8000, particularly preferably molecular weights between 200 and 4000, can be used. Moreover, a polyol can be used which comprises at least one compound with at least two or more hydroxyl groups. Preferably, the polyol comprises a composition of two or more compounds with two or more hydroxyl groups. Preferred compounds are hydroxyl-terminal polyethers such as α,ω-dihydroxypoly(oxyethylene), α,ω-dihydroxy-poly(1,2-ethylene oxide), α,ω-dihydroxypoly(propylene oxide), α,ω-dihydroxypoly(1,3-trimethylene oxide), α,ω-dihydroxypoly(1,4-tetramethylene oxide), α,ω-dihydroxy-poly(methyleneoxy-1,2-ethylene oxide), and copolymers thereof, which preferably have a molecular weight of up to 15,000 g/mol, hydroxyl-terminal aliphatic polycarbonates such as α,ω-dihydroxypoly(ethylene carbonate), α,ω-dihydroxypoly(1,2-propylene carbonate), α,ω-dihydroxypoly(1,3-propylene carbonate), α,ω-dihydroxypoly(tetramethylene carbonate), α,ω-dihydroxy-poly(hexamethylene carbonate), and copolymers thereof which preferably have a molecular weight of up to 15,000 g/mol, polyanhydrides of dicarboxylic acids, such as malonic acid, succinic acid, glutaric acid, and copolymers thereof which preferably have a molecular weight of up to 15,000 g/mol, low molecular weight or polyvalent alcohols such as glycol, 1,2-propylene glycol, 1,3-propylene glycol, butanediol, pentanediol, hexaneddol and long-chain, linear or branched, aliphatic diols, glycerol, triethanolamine, pentaerythritol, 2,2-bis(hydroxymethyl)propanol; amino acid dimers, trimers, and oligomers containing hydroxyl groups, e.g. by tyrosine and/or serine; and sugar alcohols such as sorbitol and other natural compounds or derivatives of natural compounds which have at least two hydroxyl groups. Furthermore, polyester triols such as castor oil and sulfonated castor oil can be used. Preferably, polyester triols are added to the polyol. This leads to a higher polymerization density within the polyurethane.

Preferably, polyesters with hydroxyl groups are encompassed by the polyol. Examples of such compounds are: polycaprolactonediol and polycaprolactonetriol. Further examples are α,ω-dihydroxypoly(D,L-lactide), α,ω-dihydroxypoly(D-lactide), α,ω-dihydroxypoly(L-lactide), ,ω-dihydroxypoly(glycolide), α,ω-dihydroxypoly(hydroxybutyrate) and other aliphatic polyesters and their copolymers including segmented block copolymers of polyether and polyester segments, as obtainable by the reaction with high molecular weight polyesters with hydroxyl-terminal poly (alkylene glycols), and also a composition of such polyols.

Particular preference is given to compounds which are biocompatible. Examples of such compounds are poly(ε-caprolactone) (PCL), poly(ε-caprolactone-coglycolide-co-DL-lactide), branched and unbranched polyethylene glycols (PEG), PCL-b-PEG-b-PCL, (α,ω-dihydroxy-oligo((R)-3-hydroxybutyrate-co-(R)-3-hydroxyvalerate)-block-ethylene glycol).

In a particularly preferred embodiment, the polyol comprises a composition of at least one polyethylene glycol and a poly(ε-caprolactone). The at least one polyethylene glycol can be branched or unbranched and preferably have an average molecular weight of from 100 to 15,000, particularly preferably between 300 and 5000. Preferably, the polyol comprises a composition of polyethylene glycols with different average molecular weights, The at least one poly(s-caprolactone) can be branched or unbranched and preferably have a molecular weight between 100 and 15,000, particularly preferably between 100 and 1000.

In a second step, at least one solution of a polar solvent comprising at least one additive soluble in polar solvents, in particular a water-soluble or alcohol-soluble additive, in particular a biocide, and also at least one carrier material for the additive soluble in polar solvents is added to the polyol or polyols.

An additive soluble in polar solvents incorporated into a polyol under these conditions is particularly storage-stable. Without being bound to one theory, it is assumed that the additive soluble in polar solvents can be reversibly adsorbed to the surface of the carrier material, for example via hydrogen bridge bonds, van-der-Waals forces or ionic bonds, such that it is released from the two-component polyurethane.

After adding at least one solution of a polar solvent comprising at least one additive soluble in polar solvents, in particular a water-soluble or alcohol-soluble additive, in particular a biocide, and the carrier material for the additive soluble in polar solvents to the polyol or polyols, in a further step at least one isocyanate is provided in order to then add it to this mixture and, with the further addition of a catalyst, to obtain a two-component polyurethane composition comprising at least one additive soluble in polar solvents. As a result of the above-described storage stability of the polyol mixture comprising at least one additive soluble in polar solvents and at least one carrier material for additives soluble in polar solvents, the addition of at least one isocyanate can optionally also take place at a different time.

Particular preference is given to aliphatic isocyanates such as 1,6-diisocyanatohexane (HDI) or dicyclohexamethane diisocyanate (H12MDI) or their prepolymers. Furthermore, preferred isocyanates are substituted or unsubstituted alkylene diisocyanates with 3 to 12 carbon atoms such as e.g. lysine ddisocyanate, substituted or unsubstituted cycloalkylene diisocyanates with 5 to 15 carbon atoms such as cyclohexylene diisocyanate; substituted or unsubstituted alkylcycloalkylene dilsocyanates having 6 to 18 carbon atoms such as isophorone diisocyanate; substituted or unsubstituted aromatic dlisocyanates such as p-phenylenediisocyanate, tolyienediisocvanate (all isomers and compositions thereof), 4,4′-diphenylmethane diisocyanate, and isomers, trimers, higher oligomers, uretdiones, cyanurates and isocyanurates of these diisocyanates.

Moreover, particular preference is given to 1,4-diisocyanatobutane isophorone diisocyanate (IPDI), lysimethyl ester diisocyanate (LDI) or 4,4′-diphenylmethane diisocyanate (MDI).

The provision as required of at least one isocyanate in the method described above takes place for example by using the isocyanate or isocyanates packaged together with at least one polyol, with at least one solution of a polar solvent comprising at least one additive soluble in polar solvents, in particular a water-soluble or alcohol-soluble additive, in particular a biocide, and with at least one carrier material for additives soluble in polar solvents, and/or directions are to be found on or in the packaging which explain the use of the isocyanate or isocyanates.

A further method for producing a two-component polyurethane composition comprising at least one additive soluble in polar solvents, in particular a water-soluble or alcohol-soluble additive, in particular a biocide, is characterized in that it involves the following steps:

a) mixing at least one solution of a polar solvent comprising at least one additive soluble in polar solvents, in particular a water-soluble or alcohol-soluble additive, in particular a biocide, with at least one carrier material for the additive soluble in polar solvents;
b) drying of the mixture from step a);
c) adding the dried mixture from step b) to at least one polyol; and
d) provision as required of at least one isocyanate for the addition to the mixture from step c).

The water-soluble additives added to a two-component polyurethane composition in this method have a solubility in water of at least 10% by weight, preferably of 25% by weight and particularly preferably of 40% by weight.

Preferably, the additives soluble in polar solvents are the aforementioned additives, their derivatives and mixtures thereof. The polar solvents are likewise described above.

The carrier material used in this method for additives soluble in polar solvents is also that mentioned above.

In the method, in a first step, firstly at least one solution of a polar solvent comprising at least one additive soluble in polar solvents, in particular water-soluble or alcohol-soluble additive, in particular a biocide, is mixed with at least one carrier material for additives soluble in polar solvents.

This mixture is then dried, followed by the addition of the dried mixture to at least one polyol.

Suitable polyols are described above.

In a further step, at least one isocyanate is provided in order to add it to this mixture and to complete a polymerization of a two-component polyurethane composition with the aid of a catalyst.

After adding at least one solution of a polar solvent comprising at least one additive soluble in polar solvents, in particular a water-soluble or alcohol-soluble additive, in particular a biocide, to at least one polyol, in a further step at least one isocyanate is provided in order to then add it to this mixture.

Suitable isocyanates are described above.

The provision as required of at least one isocyanate in the method described above takes place by using the isocyanate or isocyanates packaged together with at least one polyol, at least one solution of a polar solvent comprising at least one additive soluble in polar solvents, in particular a water-soluble or alcohol-soluble additive, in particular a biocide, and at least one carrier material for additives soluble in polar solvents, and/or directions are to be found on or in the packaging which explain the use of the provided isocyanate or isocyanates.

Furthermore, the present invention relates to a two-component polyurethane composition comprising at least one additive soluble in polar solvents, in particular a water-soluble or alcohol-soluble additive, in particular a biocide, and at least one carrier material for the additive soluble in polar solvents obtainable by one of the two production methods described above.

The additives of the composition soluble in polar solvents have a solubility in water of at least 10% by weight, preferably of 25% by weight and particularly preferably of 40% by weight. Preferably used additives and carrier materials, as well as their possible interactions are described above. Similarly, the polar solvents are those described above.

The polyurethane is synthesized from at least one polyol and at least one isocyanate, Preferably used polyols and isocyanates are described above.

The provision as required of at least one isocyanate in the above-described two-component polyurethane composition takes place by using the isocyanate or isocyanates packaged together with at least one polyol, at least one solution of a polar solvent comprising at least one additive soluble in polar solvents, in particular a water-soluble or alcohol-soluble additive, in particular a biocide, and at least one carrier material for the additive soluble in polar solvents, and/or directions can be found on or in the packaging which explain the use of the provided isocyanate or isocyanates.

Moreover, the present invention relates to a polyurethane obtainable by the methods described above, and comprising an additive soluble in polar solvents, in particular a water-soluble or alcohol-soluble additive, in particular a biocide, which is applied to a carrier material by reacting to completion at least one provided isocyanate with the mixture of at least one polyol and at least one additive soluble in polar solvents which is applied to at least one carrier material.

The solubility in water of the additives soluble in polar solvents, and also the polar solvents are as described above,

The additives soluble in polar solvents are those mentioned above, their derivatives or mixtures thereof.

The carrier material for additives soluble in polar solvents, and also the possible interaction between carrier material and additive is described above.

The polyurethane is synthesized from at least one polyol and at least one isocyanate.

Preferably used polyols and isocyanates are described above.

The reaction to give the polyurethane between the polyol mixture comprising at least one additive soluble in polar solvents applied to at least one carrier material and at least one isocyanate takes place with the addition of at least one catalyst.

Suitable catalysts are organometallic catalysts and/or catalysts comprising tertiary amines. Particular preference is given to using a bismuth catalyst and/or a 2′,2′-dimorpholinyldiethyl ether. The concentration of the catalysts here is preferably in the range from 0.01 to 1.00 percent by weight.

Furthermore, the present invention relates to the use of a two-component polyurethane mixture comprising at least one additive soluble in polar solvents, in particular a water-soluble or alcohol-soluble additive, in particular at least one biocide, and at least one carrier material for additives soluble in polar solvents for producing a foam or an adhesive.

The polar solvents, and also preferably used additives soluble in polar solvents, their derivatives or mixtures thereof and their solubility in water are as described above.

Similarly, the carrier material and the possible interaction between carrier material and additive are as described above.

Furthermore, the present invention relates to the use of a polyurethane comprising at least one additive soluble in polar solvents, in particular a water-soluble or alcohol-soluble additive, in particular a biocide, and at least one carrier material for additives soluble in polar solvents for producing a foam or an adhesive.

The polar solvents, the additives soluble in polar solvents, their derivatives and mixtures thereof, their solubility in water, the carrier material and the possible interactions of carrier material and additive are as described above.

Furthermore, the invention relates to a two-component kit comprising, in separate compartments, (i) at least one polyol and at least one solution of a polar solvent, preferably a protic solvent, particularly preferably water or alcohol, comprising an additive soluble in polar solvents in particular a biocide, and at least one carrier material for the additive and (ii) at least one isocyanate, and also a three-component kit comprising, in separate compartments, (i) at least one polyol, (ii) at least one solution of a polar solvent, preferably of a protic solvent, particularly preferably water or alcohol, comprising an additive soluble in polar solvents, in particular a biocide, and a carrier material for the additive and (iii) at least one isocyanate.

The polyols, isocyanates, polar solvents, the additives soluble in polar solvents, their derivatives and mixtures thereof, their solubility in water, the carrier material and the possible interactions of carrier material and additive are as described above.

### WORKING EXAMPLES

### Example 1

### Comparative Example—Incorporation of High Concentration of PHMB Into a Polyol Mixture

67.49 p of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a mixture was prepared consisting of 20 g of PEG 400, 10 g of aqueous 20% PHMB solution (water fraction 8 g). The mixture immediately turned cloudy, which is attributed to a precipitation of the PHMB. After dispersion has taken place by means of a dispersing disk (d=6 cm) at 1000 rpm, 12.18 g of this masterbatch were added to the polyol mixture at 75-80° C. and vigorously stirred, during which the cloudiness of the mixture did not dissolve. Then, 4.55 g of Coscat 83 and 2.28 g of DMDEE were added and the mixture was held for 90 min at best subatmospheric pressure and 90° C. The mixture was transferred to a sheet-metal pack and stored overnight at 70°. A sticky precipitate was formed at the bottom of the pack. The analogous preparation of a mixture with 3.96 g of water instead of the 20% strength aqueous PHMB solution did not lead to any precipitation during the mixing and also after prolonged storage.

### Example 2

### Incorporation of an Aqueous PHMB Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 20% PHMB solution and 2.5 g of Aerosil 200. After dispersion has taken place by means of a dispersing disk (d=6 cm) at 1000 rpm, 12.18 g of this masterbatch were added to the polyol mixture at 75-80° C. and vigorously stirred. Then, 4.1 g of Coscat 83 and 2.16 g of DMDEE were added. A white, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C. The mixture was then held at 100° C. for 1 h. A foam with small homogeneous pores was formed.

### Example 3

### Incorporation of an Aqueous PHMB Solution and of a Carrier Material Into a Polyol Mixture and Production of a Polyurethane Foam

102.48 g of PEG 400, 1.98 g of Turkey red oil, 10.50 g of PVP and 118.81 g of PEG 4000 were introduced into a flat-flange beaker and melted at a bath temperature of 90° C. Then, 1 g of Aerosil 200 was dispersed in. Subsequently, 3.96 g of a 20% strength, aqueous PHMB solution were added. The mixture turned slightly cloudy. Then, 4.55 g of Coscat and 2.28 g of DMDEE were added and the mixture was dewatered for 90 min at 90° C. and best subatmospheric pressure.

22.6 g of this polymer mixture were than admixed with 0.3 g of water, mixed with 20.61 g of Desmodur E 305 and 1.79 g of Desmodur N 3600 in the Speedmixer for 30 sec and 1200 rpm and stored for 30 min at an oven temperature of 110°. A foam with relatively small, homogeneous pores was formed.

### Example 4

### Incorporation of an Aqueous PHMB Solution and of a Carrier Material Into a Polyol Mixture and Production of a Polyurethane Contact Adhesive (PSA)

250 g of Levagel VP KA 8732 (OHN 35, tetrafunctional) and 0.5 g of tocopherol were introduced into a flat-flange beaker and admixed with 5 g of Aerodisp G 1220 (dispersion of hydrophilic silica in ethylene glycol). Subsequently, 3.96 g of a 20% strength, aqueous PHMB solution were added. Then, 1 g of Coscat 83 was added, the mixture was heated to 90° C. and dewatered for 3 h at best subatmospheric pressure.

23.4 a of this polyol mixture were mixed at room temperature in the Speedmixer with Desmodur VP LS 2371 (aliphatic prepolymer based on IPDI, NCO content 3.8%) for 1 min and 1200 rpm and then the mixture was knife-coated onto siliconized paper in a layer thickness of 100 μm. A transparent film with contact-adhesive properties was formed.

### Example 5

### Incorporation of an Aqueous PHMB Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 20% PHMB solution and 2.5 g of Aerosil 200. After dispersion had taken place by means of a dispersing disk (d=6 cm) at 1000 rpm and dewatering at 90° C. over 6 hours, 9.18 g of this masterbatch were added to the polyol mixture at 75-80° C. and vigorously stirred. The water content of the masterbatch was 0.184% according' to Karl-Fischer titration. Subsequently, 4.1 g of Coscat 83 and 2.16 g of DMDEE were added. A white, homogeneous, fine suspension was formed.

22.6 g of this polyol mixture were then mixed with 0.3 g of water, mixed with 20.61 g of Desmodur E 305 and 1.79 g of Desmodur N 3600 in a Speedmixer for 30 sec and 1200 rpm and stored for 30 min at an oven temperature of 110°. A foam with relatively small, homogeneous pores was formed.

### Example

### Comparative Example—Incorporation of a High Concentration of Chlorhexidine Into a Polyol Mixture

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a mixture was prepared consisting of 20 g of PEG 400 and 10 g of aqueous 20% chlorhexidine solution. After dispersion had taken place by means of a dispersing disk (d=6 cm) at 1000 rpm, 12.18 g of this masterbatch were added to the polyol mixture at 75-80° C. and vigorously stirred. Subsequently, 4.55 g of Coscat 83 and 2.28 g of DMDEE were added and the mixture was held for 90 min at best subatmospheric pressure and 90° C. A white, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C. Subsequently, the mixture was held for 1 h at 100° C. A foam with small homogeneous pores was formed. However, storage for a few days of the polyol in the oven at 70° C. resulted in precipitations at the bottom of the pack!

### Example 7

### Incorporation of an Aqueous Chlorhexidine Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 20% chlorhexidine solution and 2.5 g of bentonite. After dispersion had taken place by means of a dispersing disk (d=6 cm) at 1000 rpm, 12.18 g of this masterbatch were added to the polyol mixture at 75-80° C. and vigorously stirred. Subsequently, 4.1 g of Coscat 83 and 2.16 g of DMDEE were added. A grayish, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C. Subsequently, the mixture was held at 100° C. for 1 h. A foam with small homogeneous pores was formed. Storage for a few days of the polyol in the oven at 70° C. resulted in slight precipitations at the bottom of the pack.

### Example 8

### Incorporation of an Aqueous Chlorhexidine Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo.

In parallel to this, a dispersion was prepared consisting of 20 g of PEG 400, 10 g of aqueous 20% chlorhexidine solution and 2.5 g of Aerosil 200. After dispersion had taken place by means of a dispersing disk (d=6 cm) at 1000 rpm, 12.18 g of this masterbatch were added to the polyol mixture at 75-80° C. and vigorously stirred. Subsequently, 4.1 g of Coscat 83 and 2.16 g of DMDEE were added. A white, homogeneous, fine suspension was formed.

22.88 g of this polyol were then introduced at 70° C. into a 250 ml PP beaker with screw lid including small hole and mixed. in a SpeedMixer™ (Hauschild) for 30 sec and 1200 rpm with 22.12 g of Desmodur E 305 (HDI-based prepolymer with NCO content of 13%), which was likewise preheated to 70° C. Subsequently, the mixture was held for 1 h at 100° C. A foam with small homogeneous pores was formed. Precipitations were not observed.

### Example 9

### Incorporation of an Aqueous Tauroline Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 2% tauroline solution and 2.5 g of bentonite. After dispersion had taken place by means of a dispersing disk (d=6 cm) 1000 rpm, 12.18 g of this masterbatch were added to the polyol mixture at 75-80° C. and vigorously stirred. Subsequently, 4.1 g of Coscat 83 and 2.16 g of DMDEE were added. A grayish, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C. Subsequently, the mixture was held for 1 h at 100° C. A foam with small homogeneous pores was formed. Precipitations were not observed.

### Example 10

### Incorporation of an Aqueous Tauroline Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 2% tauroline solution and 2.5 g of Aerosil 200. After dispersion had taken place by means of a dispersing disk (d=6 cm) at 1000 rpm, 12.18 g of this masterbatch were added to the polyol mixture at 75-80° C. and vigorously stirred. Subsequently, 4.1 g of Coscat 83 and 2.16 g of DMDEE were added. A white, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C., Subsequently, the mixture was held for 1 h at 100° C. A foam with small homogeneous pores was formed. Precipitations were not observed.

### Example 11

### Incorporation of an Aqueous PHMB Solution and of a Carrier Material Into a Polyol Mixture and Production of a Polyurethane Foam

67.49 g of PEG-400, 112.49 g of PEG-4000, 37.50 g of castor oil, 9.94 g of PVP and 1.87 g of Turkey red oil were melted at 100-110° C. and briefly degassed in vacuo. In parallel to this, a dispersion was prepared consisting of 20 g of PEG 400, 10 g of aqueous 20% PHMB solution and 2.5 g of bentonite. After dispersion had taken place by means of a dispersing disk (d=6 cm) at 1000 rpm, 12.18 g of this masterbatch were added to the polyol mixture at 80° C. and vigorously stirred. Subsequently, 4.1 g of Coscat 83 and 2.16 g of DMDEE were added. A grayish, homogeneous, fine suspension was formed.

22.88 g of this polyol were then introduced at 70° C. into a 250 ml PP beaker with screw lid including small hole and mixed in the SpeedMixer™ (Hauschild) for 30 sec and 1200 rpm with 22.12 g of Desmodur E 305 (HDI-based prepolymer with NCO content of 13%), which was likewise preheated to 70° C. Subsequently, the mixture was held for 1 h at 100° C. A foam with small homogeneous pores was formed. However, storage for one day of the polyol in the oven at 70° C. resulted in slight precipitations at the bottom of the pack.

1-14. (canceled)

15. A method for producing a two-component polyurethane composition comprising at least one additive soluble in polar solvents, said method comprising steps of:
a) providing of at least one polyol;
b) adding
at least one solution of the polar solvent, preferably of a protic solvent, particularly preferably water or alcohol, comprising at least one additive soluble in polar solvents; and
at least one carrier material for the additive
to the polyol from step a); and
c) providing as required of at least one isocyanate for addition to the mixture from step b).

16. The method as claimed in claim 15, wherein the additive soluble in polar solvents has a solubility in water of at least 10% by weight.

17. The method as claimed in claim 16, wherein the additive soluble in polar solvents is selected form the group consisting of polyhexamethylenebiguanide, DMDM hydantoin, cetylpyridinium chloride, clioquinol, triclosan, triphenylmethane dyes, and derivatives and mixtures thereof.

18. The method as claimed in claim 17, wherein the carrier material for the water-soluble additive is an inorganic filler.

19. A two-component polyurethane composition made by a method as claimed in claim 18.

20. The two-component polyurethane composition as claimed in claim 19, wherein the additive soluble in polar solvents has a solubility in water of at least 1% by weight.

21. The two-component polyurethane composition as claimed in claim 20, wherein the additive soluble in polar solvents is selected form the group consisting of polyhexamethylenebiguanide, DMDM hydantoin, cetylpyridinium chloride, clioquinol, triclosan, chlorhexidine, tauroline, a triphenylmethane dye, and derivatives and mixtures thereof.

22. The two-component polyurethane composition as claimed in claim 21, wherein the carrier material for the additive soluble in polar solvents is an inorganic filler.

23. A polyurethane made by a method as claimed in claim 18, wherein at least one isocyanate is reacted to completion with at least one polyol to which at least one solution of a polar solvent, comprising an additive soluble in polar solvents and at least one carrier material for the additive is added.

24. The method of producing a foam or an adhesive of a two-component polyurethane composition as claimed in claim 22.

25. The method of producing a foam or adhesive of a polyurethane as claimed in claim 23.

26. A method for producing a two-component polyurethane composition comprising at least one additive soluble in polar solvents, said method comprising steps of:
a) mixing
at least one solution of the polar solvent, comprising at least one additive soluble in polar solvents, in particular a biocide; with
at least one carrier material for the additive;
b) drying the mixture from step a);
c) adding of the dried mixture from step b) to at least one polyol; and
d) providing as required of at least one isocyanate for the addition to the mixture from step c).

27. The method as claimed in claim 26, wherein the additive soluble in polar solvents has a solubility in water of at least 10% by weight.

28. The method as claimed in claim 27, wherein the additive soluble in polar solvents is selected form the group consisting of polyhexamethylenebiguanide, DMDM hydantoin, cetylpyridinium chloride, clioquinol, triclosan, triphenylmethane dyes, and derivatives and mixtures thereof.

29. The method as claimed in claim 28, wherein the carrier material for the water-soluble additive is an inorganic filler.

30. A two-component polyurethane composition made by a method as claimed in claim 29.

31. The two-component polyurethane composition as claimed in claim 30, wherein the additive soluble in polar solvents has a solubility in water of at least 1% by weight.

32. The two-component polyurethane composition as claimed in claim 31, wherein the additive soluble in polar solvents is selected form the group consisting of polyhexamethylenebiguanide, DMDM hydantoin, cetylpyridinium chloride, clioquinol, triclosan, chlorhexidine, tauroline, a triphenylmethane dye, and derivatives and mixtures thereof.

33. The two-component polyurethane composition as claimed in claim 32, wherein the carrier material for the additive soluble in polar solvents is an inorganic filler.

34. A polyurethane made by a method as claimed in claim 29, wherein at least one isocyanate is reacted to completion with at least one polyol to which at least one solution of a polar solvent, comprising an additive soluble in polar solvents and at least one carrier material for the additive is added.

35. The method of producing a foam or an adhesive of a two-component polyurethane composition as claimed in claim 33.

36. The method of producing a foam or adhesive of a polyurethane as claimed in claim 34.

37. A two-component kit comprising, in separate compartments,
(i) at least one polyol and at least one solution of a polar solvent, comprising an additive soluble in polar solvents, in particular a biocide, and at least one carrier material for the additive and
(ii) at least one isocyanate.

38. A three-component kit comprising, in separate compartments,
(i) at least one polyol;
(ii) at least one solution of a polar solvent, comprising an additive soluble in polar solvents and a carrier material for the additive; and
(iii) at least one isocyanate.
